(19) United States
(12) Patent Application Publication
(10) Pub. No.: US 2016/0223341 A1
(43) Pub. Date: Aug. 4, 2016

(54) GRAPH-BASED NAVIGATION USING LIGHTING EFFECTS

(71) Applicant: PHILIPS LIGHTING HOLDING B.V., Eindhoven (NL)

(72) Inventors: DIRK VALENTINUS RENÉ ENGELEN, HEUSDEN-ZOLDER (BE); BARTEL MARINUS VAN DE SLUIS, EINDHOVEN (NL); PHILIP STEVEN NEWTON, WAALRE (NL); DZMITRY VIKTOROVICH ALIAKSEYEU, EINDHOVEN (NL)

(21) Appl. No.: 15/021,312

(22) PCT Filed: Aug. 27, 2014
(86) PCT No.: PCT/IB2014/064080

§ 371 Date: Mar. 11, 2016

Related U.S. Application Data
(60) Provisional application No. 61/876,276, filed on Sep. 11, 2013.

(51) Int. Cl. G01C 21/20; H04B 10/116

(52) U.S. Cl. CPC G01C 21/206; H04B 10/116

(57) ABSTRACT

Methods, lighting control systems, mobile computing devices and computer-readable media are described herein for graph-based navigation through an environment(100). In various embodiments, a graph (220) including a plurality of nodes and a plurality of edges may be provided, e.g., by a lighting control system(130), to mobile computing devices (350) such as smart phones and tablets carried through the environment. Each node may correspond to a location of a lighting effect produced by a particular light source within the environment. Each edge may correspond to a path between two nodes. Data indicative of a path travelled through the graph by one or more mobile computing devices between a first node corresponding to a first location and a second node corresponding to a second location may be used to update the graph. Mobile computing devices may utilize the graph to calculate optimal paths (220) and/or guide users through the environment.

### TECHNICAL FIELD

The present disclosure is directed generally to navigation using lighting effects.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications.

Navigation technology exists for enabling mobile computing devices such as smart phones and tablet computers to guide a user through an environment such as a store. A mobile computing device may track its location within the environment using GPS or other location-determining means. Data representative of a two or three dimensional map of the environment may be transmitted to the mobile computing device. The mobile computing device may render the map on a display, along with the user's current location. In some cases, the mobile computing device may calculate an optimal path from one location in the environment to another, and instruct the user on how to follow the optimal path.

However, the data corresponding to the two or three dimensional map may be relatively complex. The mobile computing device may not have the communication capability, or the flexibility from a security standpoint, to receive such data. Additionally, the mobile computing device may not have the capability to properly display a corresponding map. Moreover, calculation of optimal paths through a two or three dimensional map may be resource-intensive. And updating the two or three dimensional map in the event that the environment is physically reconfigured (e.g., shelves/furniture are moved) may be cumbersome.

Thus, there is a need in the art for simpler mechanisms to navigate a mobile computing device user through an environment. There is also a need in the art to provide a simpler and/or more automated way to update navigational data in the event that an environment is physically reconfigured.

### SUMMARY

The present disclosure is directed generally to graph-based navigation using lighting effects. For example, various inventive methods, systems, computer-readable media, and apparatus disclosed herein relate to graph-based navigation using a graph that includes a plurality of nodes and a plurality of edges, each node corresponding to a location of a lighting effect within the environment, and each edge representing a path between two nodes.

Generally, in one aspect, a computer-implemented method may include providing, by a lighting control system to a mobile computing device, a graph comprising a plurality of nodes and a plurality of edges, each node corresponding to a location of a lighting effect produced by a particular light source within the environment, and each edge representing a path between two nodes. The method may further include receiving, by the lighting control system, data indicative of a path travelled through the graph by the mobile computing device between a first node corresponding to a first location and a second node corresponding to a second location.

In various embodiments, the graph may be a first graph, and the method may further include generating, by the lighting control system, a second graph based on the first graph and the received data indicative of the path, wherein the second graph comprises a second plurality of edges that is different than the plurality of edges of the first graph. In various versions, the generating may include calculating, by the lighting control system, an optimal path through the graph from the first node to a the second node, and determining, by the lighting control system, a difference between the calculated optimal path and the path travelled through the graph by the mobile computing device. In various versions, the mobile computing device may be a first mobile computing device, and the method may further include providing, by the lighting control system to a second mobile computing device, the second graph.

In various embodiments, the method may further include providing, by the lighting control system to the mobile computing device, a preferred path through the graph. In various versions, the method may further include obtaining, by the lighting control system, a list of one or more preferred products, identifying, by the lighting control system, one or more locations of lighting effects within the environment at which the one or more preferred products are located, and generating, by the lighting control system, the preferred path through the graph based on the identified one or more locations.

In another aspect, a computer-implemented method for navigating through an environment may include obtaining, by a mobile computing device, a graph comprising a plurality of nodes and a plurality of edges, each node corresponding to a location of a lighting effect produced by a particular light source within the environment, and each edge representing a path between two nodes. The method may further include receiving, at a light detector of the mobile computing device, a coded light signal identifying a location of a lighting effect within the environment, and calculating, by the mobile computing device, an optimal path from a first node of the graph corresponding to the identified location to a second node of the graph corresponding to a desired location within the environment.

In various embodiments, the method may further include rendering, by the mobile computing device on a display, one or more graphical elements instructing a user on how to follow the calculated optimal path. In various embodiments, the lighting effect may be a first lighting effect within the environment, the coded light signal may be a first coded light signal, and the identified location may be a first identified location. The method may further include receiving, by the mobile computing device at the light detector, a second coded light signal identifying a second location of a second lighting effect within the environment, and storing, in memory of the mobile computing device, a path travelled through the graph between the first node corresponding to the first identified location and a second node corresponding to the second identified location. In various versions, the method may further include providing, by the mobile computing device to one or more remote computing devices that provided the graph to the mobile computing device, the stored travelled path. In various embodiments, the method may further include obtaining, by the mobile computing device, a preferred path through the graph.

In another aspect, a lighting control system may include a graph provision module to provide, to a plurality of mobile computing devices that travel through an environment, a graph comprising a plurality of nodes and a plurality of edges, each node corresponding to a location of a lighting effect produced by a particular light source within the environment, and each edge representing a path between two nodes. The lighting control system may also include a feedback module to obtain feedback indicative of paths travelled through the graph by the plurality of mobile computing devices. The lighting control system may also include a graph generation module to generate the graph based at least in part on the feedback obtained by the feedback module.

In various embodiments, the graph generation module may be configured to calculate an optimal path through the graph from a first node corresponding to a first location in the environment to a second node corresponding to a second location in the environment, and to determine a difference between the calculated optimal path and a path travelled by one or more mobile computing devices from the first location to the second location. In various versions, the graph generation module may be further configured to remove an edge from the graph responsive to a determination that the edge is no longer being traversed by mobile computing devices.

In various embodiments, preferred path module may be configured to provide, to one or more mobile computing devices, a preferred path through the graph. In various versions, the preferred path module may be configured to obtain a list of one or more preferred products, identify one or more locations of lighting effects within the environment at which the one or more preferred products are located, and generate the preferred path based on the identified one or more locations.

In another aspect, a mobile computing device may include a display, a light sensor, and a controller operably coupled with the light sensor and the display. The controller may be configured to obtain a graph comprising a plurality of nodes and a plurality of edges, each node corresponding to a location of a lighting effect produced by a particular light source within an environment, and each edge representing a path between two nodes. The controller may be further configured to receive, through the light sensor, a coded light signal identifying a location of a lighting effect within the environment, and calculate an optimal path from a first node of the graph corresponding to the identified location to a second node of the graph corresponding to a desired location within the environment.

In various embodiments, the controller may be further configured to render, on the display, one or more graphical elements instructing a user on how to follow the calculated optimal path. In various embodiments, the lighting effect may be a first lighting effect within the environment, the coded light signal may be a first coded light signal, and the identified location may be a first identified location. In such embodiments, the controller may be further configured to receive, through the light detector, a second coded light signal identifying a second location of a second lighting effect within the environment, and store, in memory of the mobile computing device, a path travelled through the graph between the first node corresponding to the first identified location and a second node corresponding to the second identified location. In various versions, the controller may be further configured to provide, to one or more remote computing devices that provided the graph to the mobile computing device, the stored travelled path.

In various embodiments, the controller may be further configured to obtain a preferred path through the graph, and render, on the display, one or more graphical elements instructing a user on how to follow the preferred path.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

As used herein, the term “lighting control system” may refer to one or more controllers and other associated hardware (e.g., input/output devices, sensors, memory, etc.) and/or software modules that may be used in combination to control one or more light sources, lighting units and/or lighting fixtures.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a top-down view of an example environment illuminated by a plurality of lighting effects, each corresponding to a node of a graph, in accordance with various embodiments.

FIG. 2 depicts a portion of an example graph that may be generated showing possible paths through the environment of FIG. 1, in accordance with various embodiments.

FIG. 3 depicts an example lighting control system, in accordance with various embodiments.

FIG. 4 depicts the example environment of FIG. 1 with an obstruction added, in accordance with various embodiments.

FIG. 5 depicts the example graph of FIG. 2 updated to reflect the obstruction added to the environment of FIG. 4, in accordance with various embodiments.

FIG. 6 depicts an example method that may be implemented by a lighting control system, in accordance with various embodiments.

FIGS. 7 and 8 depict example navigational user interfaces, in accordance with various embodiments.

FIG. 9 depicts an example method that may be implemented by a mobile computing device, in accordance with various embodiments.

### DETAILED DESCRIPTION

Navigation technology exists for enabling mobile computing devices such as smart phones and tablet computers to guide a user through an environment such as a store. In some cases, a data representative of a map of the environment may be transmitted to the mobile computing device. The mobile computing device may render the map on a display, along with the user's current location, may calculate an optimal path from one location in the environment to another, and may instruct the user on how to follow the optimal path. Map data may be relatively complex, and the mobile computing device may not have the capabilities to receive or render such data. Moreover, calculation of optimal paths through a two or three dimensional map may be resource-intensive. Updating the map in the event that the environment is physically reconfigured (e.g., shelves/furniture are moved) may also be cumbersome.

Accordingly, Applicants have recognized and appreciated that it would be beneficial to provide simpler mechanisms to navigate a mobile computing device user through an environment. Applicants have also recognized and appreciated that it would be beneficial to provide a simpler and/or more automated way to update navigational data in the event that an environment is physically reconfigured. In view of the foregoing, various embodiments and implementations of the present invention are directed to graph-based navigation using lighting effects.

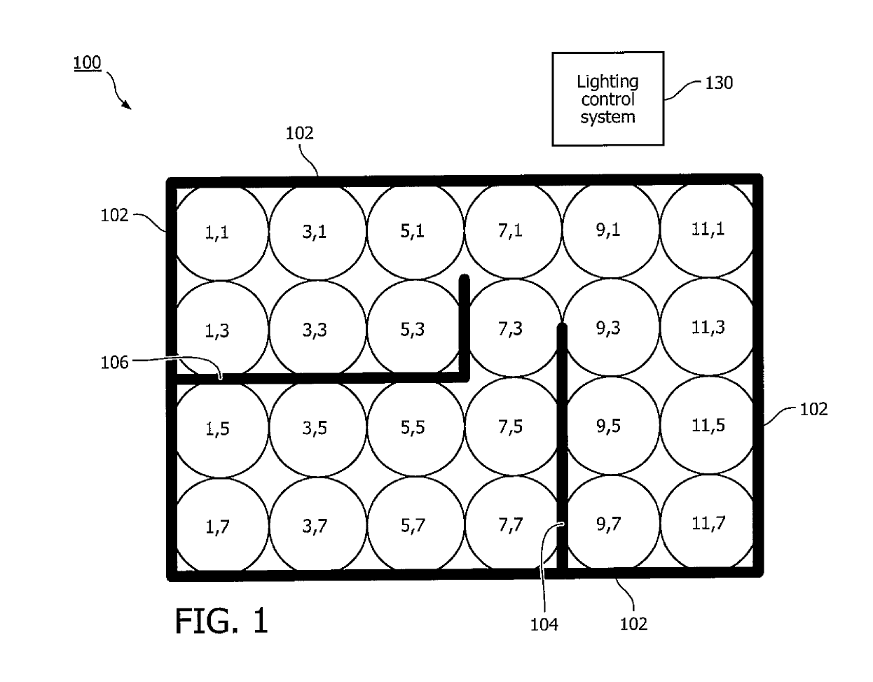

Referring to FIG. 1, an example environment 100 in the form of a room is depicted. Environment 100 is defined by four outer walls 102, a first inner wall 104 and a second inner wall 106. This is not meant to be limiting, however. These walls are selected for illustrative purposes, and it should be understood that an environment may have any number and/or configuration of walls and/or other physical objects.

A plurality of lighting effects is represented by circles with Cartesian coordinates. In various embodiments, each lighting effect may be produced by, e.g., light cast down by a ceiling-mounted LED-based lighting unit. However, this is not meant to be limiting, and lighting effects as used herein may be created using light sources mounted elsewhere, such as on the floor, on walls, on top of furniture, and so forth. And while the lighting effects are shown to have uniform sizes, this is not meant to be limiting. Various types of light sources may produce lighting effects of various sizes, and lighting effects may overlap to various extents.

In FIG. 1, the point 0,0 is at the top left of environment 100. However, this is arbitrary and can be set at any point within environment 100 or elsewhere. A first lighting effect is labeled “1,1” because its center corresponds to a point one meter in from the top and left outer walls 102. A second lighting effect is labeled “3,1” because its center corresponds to a point one meter down from top outer wall 102 and three meters in from left outer wall 102. Another lighting effect depicted below the first lighting effect is labeled “1,3” because its center corresponds to a point three meters down from top outer wall 102 and one meter in from left outer wall 102. The remaining lighting effects are labeled in a similar manner.

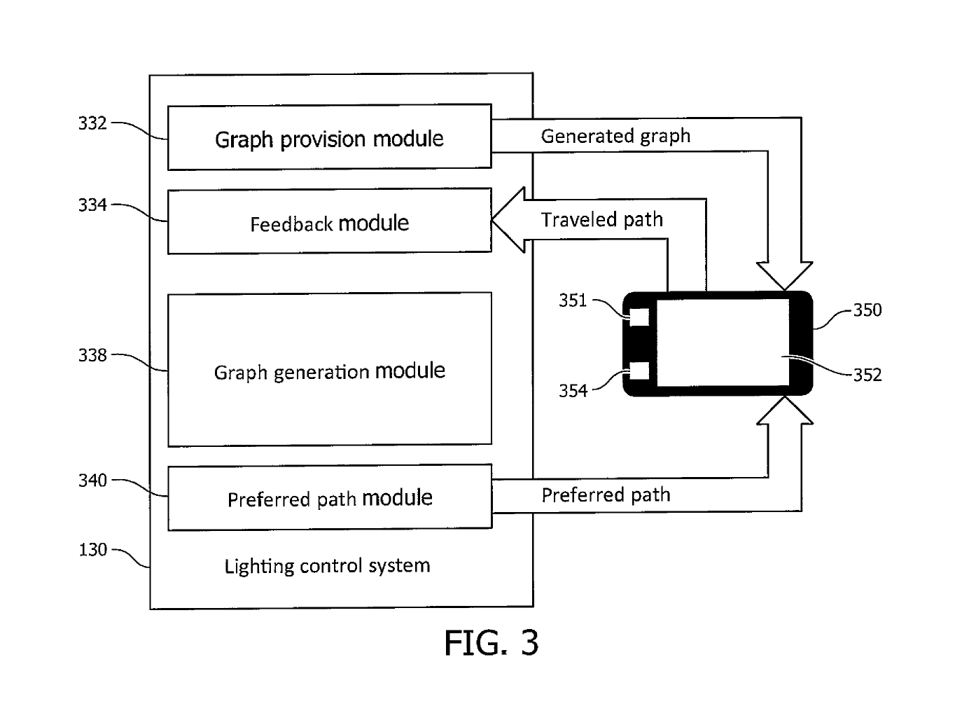

Also depicted in FIG. 1 is a lighting control system 130. Lighting control system 130 may include one or more computing devices operating together to control lighting provided by the plurality of light sources that produce the plurality of the lighting effects. In various embodiments, lighting control system 130 may be configured to communicate with the plurality of light sources in various ways, including but not limited to Wi-Fi, ZigBee, direct network connection, coded light signaling, and so forth. Lighting control system 130 will be described in more detail with reference to FIG. 3.

In various embodiments, lighting control system 130 may be configured to cause the light sources that create the lighting effects to emit coded light signals that carry the coordinates of each lighting effect. For example, the light source creating lighting effect 1,1 may emit a coded light signal carrying the Cartesian coordinates “1,1.” In other embodiments, the light source may emit a coded light signal carrying other types of location information, such as GPS coordinates, meaningful localization positions (e.g., “northwest corner of third floor,” “adjacent clothing rack 1a,” “between subway tracks 1 and 2”), and so forth.

These coded light signals may be detected by light sensors (e.g., front-facing or rear-facing cameras) of mobile computing devices such as smart phones and tablet computers. For instance, a user walking through environment 100 may, without even thinking about it, carry her smart phone with a front-facing camera pointed towards the floor. That front-facing camera may detect lighting effects, and coded light signals they carry, that are projected onto the floor from a ceiling-mounted light source such as an LED-based lighting unit. Using that information in combination with a graph that includes nodes that represent lighting effects and edges that represent paths between lighting effects, a mobile computing device may be able to determine its current position within environment 100.

Assume a user within environment 100 wishes to travel from lighting effect 1,1 to lighting effect 1,5. In various embodiments, possible routes between lighting effect 1,1 and lighting effect 1,5 may be represented by a graph that is provided, e.g., by lighting control system 130, to a mobile computing device operated by the user. The user's mobile computing device may then utilize the graph to instruct the user how to navigate between various points in environment 100.

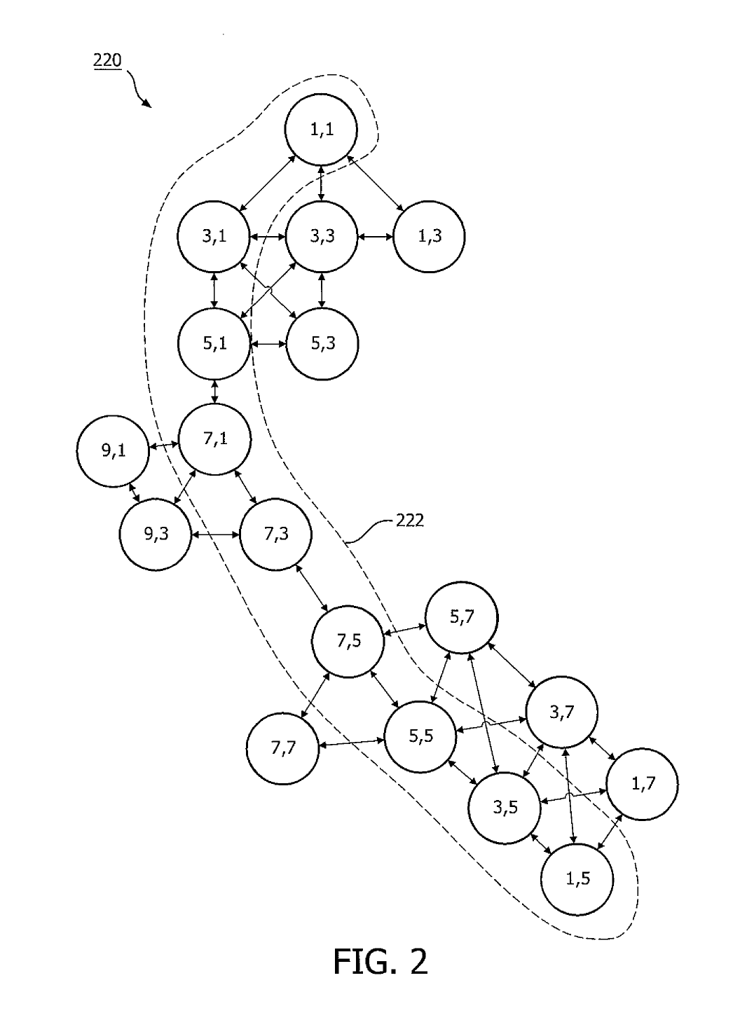

FIG. 2 depicts an example graph 220 that includes many, but not all, possible nodes and edges between lighting effects 1,1 and 1,5. Indeed, in various embodiments, graph 220 may be dense, sparse, or anywhere in between. Graph 220 may be various types of graphs, including but not limited to a directed unweighted graph, a directed acrylic graph, a directed weighted graph, and so forth. For example, in various embodiments, each edge may be assigned a numerical weight or distance, which may be used to decide between multiple edges when calculating an optimal path.

An optimal path 222 is enclosed by a dashed line in FIG. 2. This optimal path 222 may have been calculated, e.g., by the user's mobile computing device, with the assumption that each edge is at least approximately equal in weight/distance. It can be seen that while there are a number of possible paths through graph 220 from lighting effect 1,1 to lighting effect 1,5, optimal path 222 may be the quickest. An optimal path between nodes of a graph such as graph 220 may be calculated using various techniques, including but not limited to Dijkstra's algorithm, the Bellman-Ford algorithm, the “A* search” algorithm, the Floyd-Warshall algorithm, Johnson's algorithm, and so forth.

FIG. 3 depicts an example lighting control system 130, in accordance with various embodiments. Lighting control system 130 may include a graph provision module 332, a feedback module 334, a graph generation module 338, and/or a preferred path module 340. One or more of these components may be implemented using any combination of hardware and software.

In various embodiments, and as shown by the top arrow, graph provision module 332 may be configured to provide, to a plurality of mobile computing devices 350 that travel through an environment such as environment 100, a graph, such as graph 220 of FIG. 2. Graph provision module 332 may provide the graph to mobile devices 350 in various ways, including but not limiting to using Wi-Fi, other radio communications (e.g., NFC, RFID, Bluetooth, etc.), light-based communications (e.g., infrared, coded light signaling), cellular communications, WiMAX, and so forth. In some embodiments, a user of a mobile device 350 may, upon entering environment 100, receive a notification such as a text inviting the user to “register” with lighting control system 130, so that the user may be directed through environment 100. In some embodiments, mobile computing device may include a light sensor 351, a touchscreen 352, and a controller 354 (e.g., one or more processors), one or more which may be operably coupled with each other.

In various embodiments, and as shown by the middle arrow in FIG. 3, feedback module 334 may be configured to obtain feedback indicative of paths travelled through the graph by the plurality of mobile computing devices 350. For instance, when a particular mobile computing device 350 traverses a particular path between two locations corresponding to two nodes of the graph, the mobile device 350 may record the travelled path, e.g., by storing it in the mobile device's memory, and may provide data indicative of the travelled graph to lighting control system 130 (e.g., using Wi-Fi, RFID, NFC, coded light signaling, cellular, etc.).

In various embodiments, graph generation module 338 may be configured to generate and regenerate the graph over time based at least in part on the feedback obtained by feedback module 334. In this manner, graph generation module 338 is able to update the graph as the physical layout of environment 100 is altered, e.g., when furniture is moved or walls/other fixtures are added or removed.

Graph generation module 338 may be configured to alter the graph in various ways. For example, graph generation module 338 may be configured to calculate an optimal path (e.g., 222) through the graph, e.g., from a first node corresponding to a first location (e.g., the lighting effect 1,1) in environment 100 to a second node corresponding to a second location (e.g., the lighting effect 1,5) in environment 100. In various embodiments, graph generation module 338 may determine a difference between the calculated optimal path and paths through the graph that were actually travelled by mobile computing device 350 from the first location to the second location.

If differences are detected, and assuming that users would opt to take the optimal path, graph generation module 338 may surmise that a physical alteration of environment 100 has occurred which is deterring or even preventing users from taking the optimal path. Graph generation module 338 may be configured to add and/or remove one or more edges and/or nodes to/from graph 220 responsive to a determination that the one or more edges or nodes are part of optimal path 222 and are no longer being traversed by mobile computing devices 350. For instance, graph generation module 338 may alter graph 220 to reflect the surmised alteration if a predetermined number of consecutive users fail to traverse one or more edges forming a portion of optimal path 222.

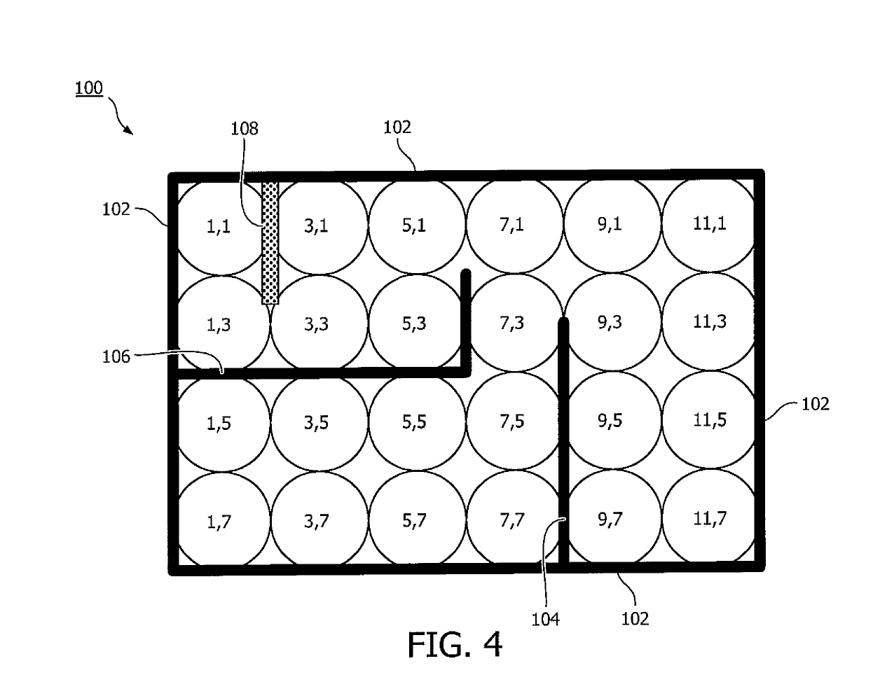

FIG. 4 depicts environment 100 of FIG. 1 with an obstruction 108 in the form of a wall having been added. Obstruction 108 prevents users from travelling directly from the lighting effect 1,1 to the lighting effects 3,1 or 3,3. Over time, and based on feedback from feedback module 334, graph generation module 338 may observe that users are no longer traversing these edges. Graph generation module 338 may update a graph (e.g., 220) of potential routes from lighting effect 1,1 to lighting effect 1,5 to reflect added obstruction 108.

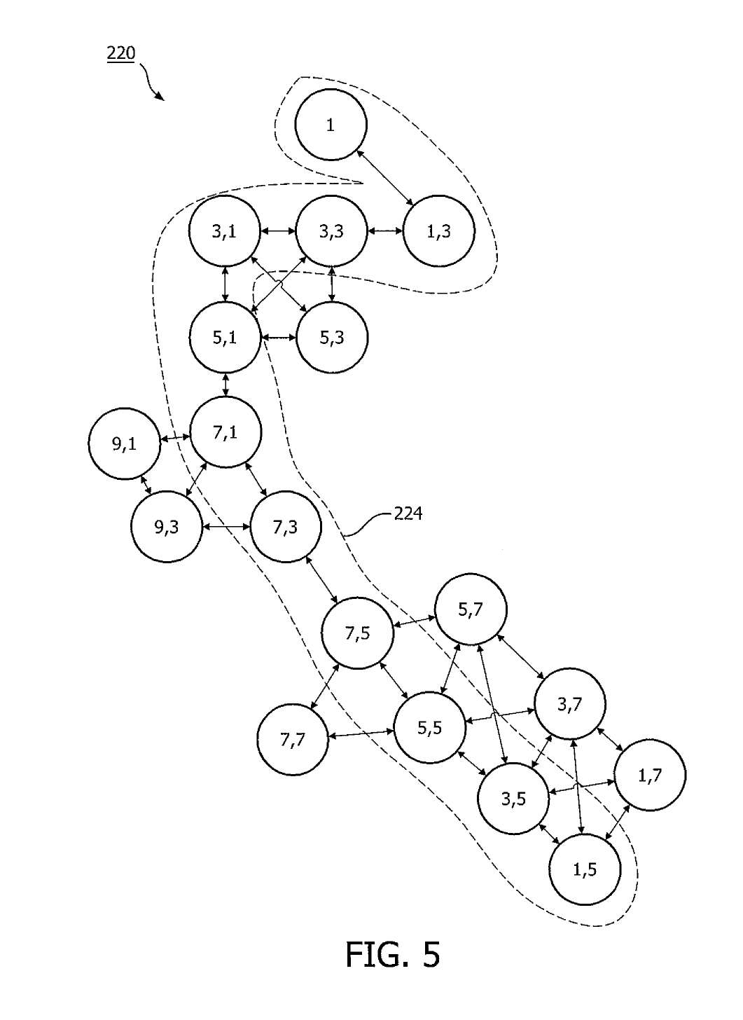

FIG. 5 depicts one example of how graph 220 of FIG. 2 may be altered to reflect the added obstruction 108 shown in FIG. 4. Edges directly between lighting effect 1,1 and lighting effects 3,1 and 3,3 are removed to reflect the addition of obstruction 108 to environment 100. Because these edges formed a portion of optimal path 222, graph generation module 338 may recalculate a new optimal path 224 which may be slightly longer than the original optimal path 222. New optimal path 224 may be one of multiple possible optimal paths.

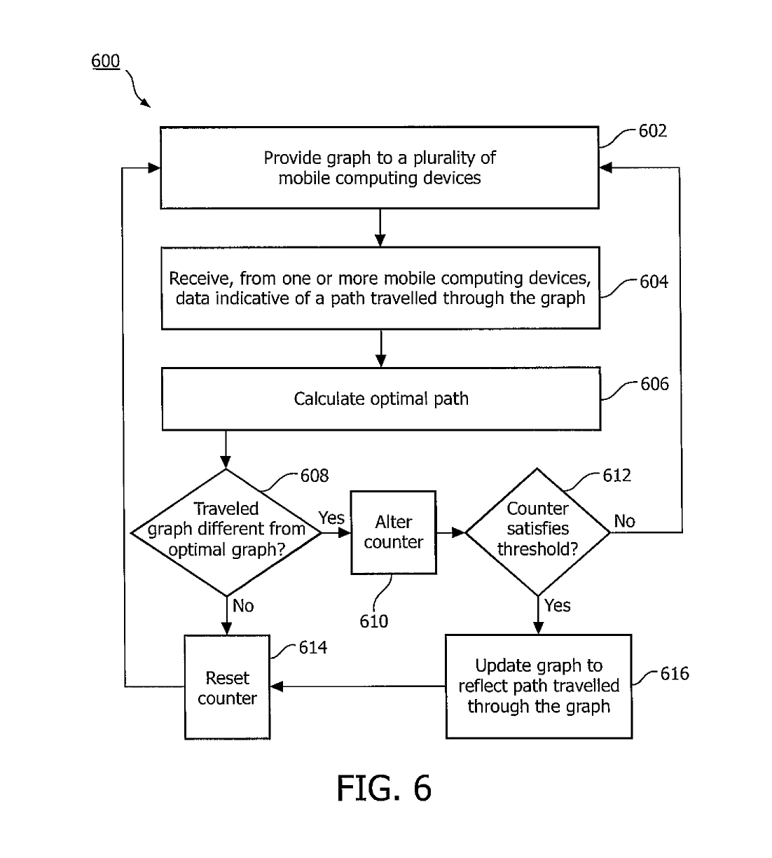

FIG. 6 depicts an example method 600 that may be implemented by lighting control system 130 or another computing system charged with facilitating navigation through an environment such as environment 100, in accordance with various embodiments. At block 602, a graph may be provided, e.g., by graph provision module 332 of lighting control system 130, to one or more mobile computing devices 350, e.g., upon one or more mobile computing devices 350 being carried into environment 100. At block 604, data indicative of a path travelled through the graph by one or more mobile computing devices 350 may be received, e.g., by feedback module 334 of lighting control system 130.

Blocks 606-612 depict one example technique for determining, e.g., by graph generation module 338 of lighting control system 130 based on feedback received by feedback module 334, whether a physical configuration of environment 100 has changed. At block 606, an optimal path (e.g., 222) from one node in graph 220 to another node may be calculated, e.g., by graph generation module 338. At block 608, it may be determined, e.g., by graph generation module 338, whether a path travelled by mobile computing device 350 is different from the calculated optimal path. If the travelled paths are different, then at block 610, graph generation module 338 may alter (e.g., increment or decrement) a counter, and method 600 may proceed to block 612. If at block 608 the travelled paths are not different, however, then at block 614, the counter may be reset (e.g., to zero, or to some other number to be decremented or incremented until a threshold is satisfied). In other embodiments, rather than comparing the optimal path to a travelled path, graph generation module 338 may instead compare a preferred path (described below) to a travelled path.

At block 612, it may be determined, e.g., by graph generation module 338, whether a count (as tracked by the counter) of differences between paths travelled by consecutive mobile computing devices 350 and the calculated optimal path satisfies a particular threshold. If not, then method 600 may proceed back to block 602. If the count satisfies the threshold (e.g., is above or equal to), on the other hand, then at block 616, the graph (e.g., 222) may be updated, e.g., by graph generation module 338, so that the updated graph (e.g., 224) has edges or nodes added or removed to account for an added or removed obstacle, the existence of which is evidenced by users repeatedly traversing or not traversing a particular edge or node. After the graph is updated at block 616, at block 614, the counter may be reset. Then, method 600 may return to block 602.

The decision to update the graph may not necessarily be in response to a counter satisfying a threshold. For example, in some embodiments, if a particular node or edge is not traversed by any mobile computing device 350 for a predetermined amount of time (e.g., a day, 72 hours, a week, etc.), then graph generation module 338 may update the graph accordingly. As another example, a user may manually update a graph, e.g., by operating a user interface associated with lighting control system 130, to indicate that an obstruction has been added at a particular location. Based on that location, graph generation module 338 may determine that particular nodes and/or edges are no longer traversable.

It may in some instances be desirable to steer users through an environment such as a store in a manner that increases the users' exposure to particular goods or services. Referring back to FIG. 3, in various embodiments, preferred path module 340 may be configured to provide, to one or more mobile computing devices 350, a preferred path through graph 220. In some embodiments, preferred path module 340 may generate a preferred path itself. For instance, it may obtain a list of one or more preferred products (e.g., via user input, from another computing system over one or more networks, etc.), and identify one or more locations of lighting effects within environment 100 at which the one or more preferred products are located. Preferred path module 340 may then generate the preferred path based on the identified one or more locations. In other embodiments, preferred path module 340 may simply receive a preferred path via manual user input. In either case, and as shown by the bottom arrow in FIG. 3, preferred path module 340 may be configured to transmit the preferred path to one or more mobile computing devices, e.g., using Wi-Fi, NFC, RFID, infrared, coded lighting signaling, and so forth.

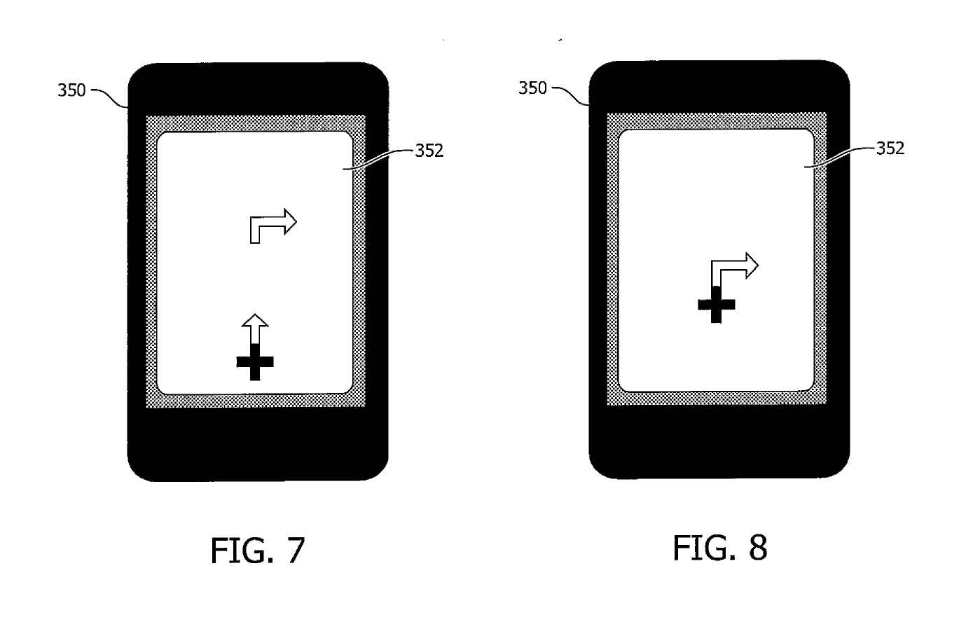

As described above, mobile computing devices 350 may be configured to use data received from lighting control system 130, such as data indicative of graph 220 and/or a preferred path, as well as an optimal path such as 222 or 224, to assist users in navigating through environments such as environment 100. FIGS. 7-8 depict an example mobile computing device 350 in the form of a smart phone with a touch screen 352 being used to render a navigational interface configured to guide a user through an environment. In various embodiments, one or more controllers of mobile computing device 350 may be configured to render one or more graphical elements instructing a user on how to follow a particular path, such as optimal paths 222 or 224, or a received preferred path.

In FIG. 7, a graphical element resembling a cross represents a user's current position. The arrow on top of the cross indicates the direction the user should travel in order to proceed towards the next change in direction, which is indicated by the elbowed right arrow. In FIG. 8, the user has closed the distance to the elbowed right arrow, and so it is time to turn right. Graphical elements such as those shown in FIG. 7 may be rendered by themselves, or may be superimposed on top of other graphics. In various embodiments, those other graphics may include simplified (e.g., vector-based) rendering of the surroundings and/or a live video feed received from, e.g., a front-facing camera.

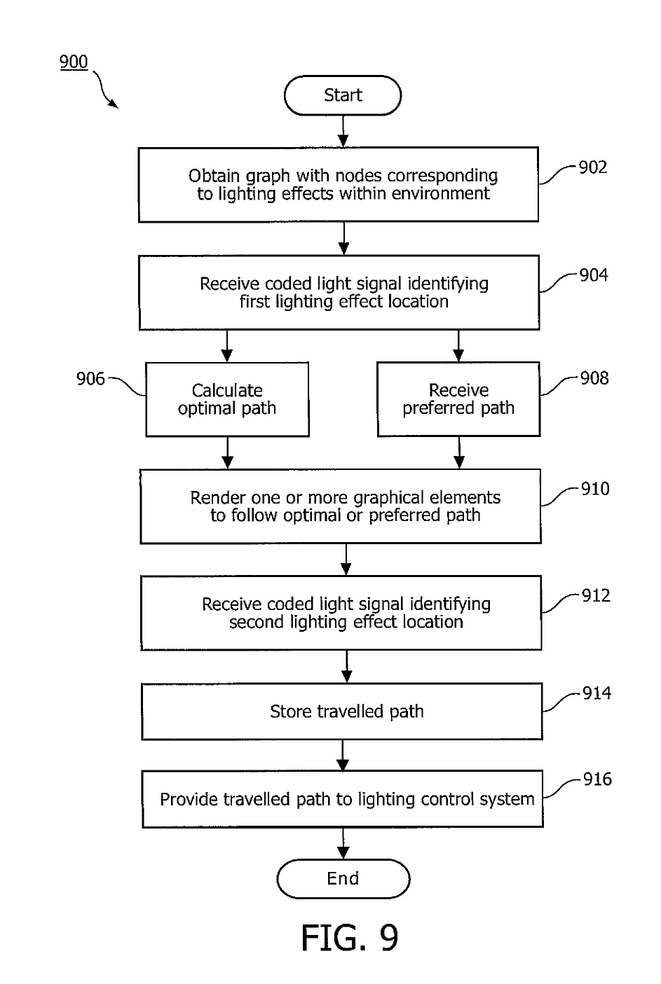

FIG. 9 depicts an example method 900 that may be implemented by a mobile computing device such as mobile computing device 350, in accordance with various embodiments. At block 902, a mobile computing device may obtain a graph comprising a plurality of nodes and a plurality of edges, each node corresponding to a location of a lighting effect within the environment, and each edge representing a path between two nodes. For instance, upon entering environment 100, mobile computing device 350 and lighting control system 130 may initiate communication, and lighting control system 130 may transmit a graph to mobile computing device 350, e.g., using Wi-Fi, Bluetooth, NFC, RFID, coded light signals, etc.

At block 904, a coded light signal identifying a first lighting effect location within the environment may be received, e.g., at a light detector of the mobile computing device. For example, as mobile computing device 350 passes under one or more light sources creating the plurality of lighting effects depicted in FIGS. 1 and 4, mobile computing device 350 may receive, e.g., from the projected lighting effect, a coded light signal carrying a Cartesian coordinate. In some embodiments, more detail information may be provided, such as a location of the lighting effect relative to its light source. Such additional detail may enable mobile computing device 350 to more accurately pinpoint its location within environment 100.

At block 906, an optimal path from a first node of the graph corresponding to the first lighting effect location to a second node of the graph corresponding to a desired location within the environment may be calculated, e.g., by mobile computing device. Additionally or alternatively, in some embodiments, at block 908, a preferred path through the graph may be obtained, e.g., by mobile computing device 350 from preferred path module 340 of lighting control system 130.

At block 910, one or more graphical elements (such as those depicted in FIGS. 7 and 8) may be rendered on a display of mobile computing device 350. In various embodiments, these graphical elements may instruct a user on how to follow the optimal path calculated at block 906 or the preferred path received at block 908. In some embodiments, a user may be able to select between being navigated along the optimal path, which may represent the fastest way to the user's desired destination in environment 100, and the preferred path, which may represent a path to the same desired location or a different desired location that will expose the user to preferred products, e.g., products on clearance. In other embodiments, the preferred path may override the optimal path, e.g., if it is more desirable to steer a customer through the preferred path than through the optimal path.

At block 912, mobile computing device 350 may receive, e.g., at its light detector, another coded light signal identifying a second lighting effect location within the environment. This may occur as the user follows the optimal or preferred path or otherwise moves through environment. At block 914, a path travelled through the graph between a first node corresponding to the first lighting effect location identified at block 904 and node corresponding to the second lighting effect location identified at block 912 may be stored in memory of mobile computing device 350.

At block 916, the travelled path may be provided, e.g., by mobile computing device 350 to one or more remote computing devices, such as graph generation module 338 of lighting control system 130. Graph generation module 338 of lighting control system 130 may then perform selected steps of method 600 to update the graph as needed.

In another aspect, graph 220 may be created initially, e.g., by lighting control system 130, in various ways. In some embodiments, an autonomous robotic device with a light sensor may travel through environment 100 to detect coded light signals in lighting effects. The autonomous robotic device may track its location using GPS or by monitoring spins of its wheels and its turns. Each time it encounters a new lighting effect, it may add a new node to a graph. If it is able to travel from one lighting effect to another and/or if the lighting effects overlap, the autonomous robotic device may add an edge between two nodes representing those lighting effects. If it encounters an obstacle between two lighting effects, it may not add an edge between the two corresponding nodes.

In other embodiments, similar actions may be performed by one or more persons carrying graph-creation devices with light sensors. In some embodiments, graph 220 may even be created by multiple users travelling through environment 100 and carrying mobile computing devices 350, using techniques similar to those described above with reference to methods 600 and 900, without those users even knowing it. For example, two nodes and an edge there between may be detected initially from feedback received from a plurality of mobile computing devices 350 carried by users travelling through environment 100. At a later time, if other users cease travelling along that edge, lighting control system 130 may remove that edge from graph 220. Likewise, if users begin traversing directly between two nodes that didn't previously have an edge between them, lighting control system 130 may add an edge.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

Also, reference numerals appearing in the claims between parentheses, if any, are provided merely for convenience and should not be construed as limiting the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A computer-implemented method, comprising:
providing, by a lighting control system to a mobile computing device, a graph comprising a plurality of nodes and a plurality of edges, each node corresponding to a location of a lighting effect produced by a particular light source within an environment; wherein the lighting control system is configured to control the lighting effect, and each edge representing a path between two nodes;
receiving, by the lighting control system, data indicative of a path travelled through the graph by the mobile computing device between a first node corresponding to a first location and a second node corresponding to a second location, and
removing an edge from the graph responsive to a determination that the edge is no longer being traversed by mobile computing devices.

2. The computer-implemented method of claim 1, wherein the graph is a first graph, and the method further comprises generating, by the lighting control system, a second graph based on the first graph and the received data indicative of the path, wherein the second graph comprises a second plurality of edges that is different than the plurality of edges of the first graph.

3. The computer-implemented method of claim 2, wherein the generating comprises:
calculating, by the lighting control system, an optimal path through the first graph from the first node to a the second node; and
determining, by the lighting control system, a difference between the calculated optimal path and the path travelled through the first graph by the mobile computing device.

4. The computer-implemented method of claim 2, wherein the mobile computing device is a first mobile computing device, and the method further comprises providing, by the lighting control system to a second mobile computing device, the second graph.

5. The computer-implemented method of claim 1, further comprising providing, by the lighting control system to the mobile computing device, a preferred path through the first graph.

6. The computer-implemented method of claim 5, further comprising:
obtaining, by the lighting control system, a list of one or more preferred products;
identifying, by the lighting control system, one or more locations of lighting effects within the environment at which the one or more preferred products are located; and
generating, by the lighting control system, the preferred path through the first graph based on the identified one or more locations.

7. At least one non-transitory computer-readable medium comprising instructions that, in response to execution of the instructions by a lighting control system, cause the lighting control system to perform the method of claim 1.

8. (canceled)

9. (canceled)

10. (canceled)

11. (canceled)

12. (canceled)

13. (canceled)

14. A lighting control system, comprising:
a first graph provision module to provide, to a plurality of mobile computing devices that travel through an environment, a graph comprising a plurality of nodes and a plurality of edges, each node corresponding to a location of a lighting effect produced by a particular light source within the environment, wherein the lighting control system is configured to control the lighting effect, and each edge representing a path between two nodes;
a feedback module to obtain feedback indicative of paths travelled through the graph by the plurality of mobile computing devices; and
a graph generation module to generate a second graph based at least in part on the feedback obtained by the feedback module, and to remove an edge from the first graph responsive to a determination that the edge is no longer being traversed by mobile computing devices.

15. The lighting control system of claim 14, wherein the graph generation module is further configured to calculate an optimal path through the first graph from a first node corresponding to a first location in the environment to a second node corresponding to a second location in the environment, and to determine a difference between the calculated optimal path and a path travelled by one or more mobile computing devices from the first location to the second location.

16. (canceled)

17. The lighting control system of claim 14, further comprising a preferred path module to provide, to one or more mobile computing devices, a preferred path through the first graph.

18. The lighting control system of claim 17, wherein the preferred path module is configured to:
obtain a list of one or more preferred products;
identify one or more locations of lighting effects within the environment at which the one or more preferred products are located; and
generate the preferred path based on the identified one or more locations.

19. (canceled)

20. (canceled)

21. (canceled)

22. (canceled)

23. (canceled)
